(19) United States
(12) Patent Application Publication
(10) Pub. No.: US 2025/0088019 A1
(43) Pub. Date: Mar. 13, 2025

(54) RECHARGEABLE DC BATTERY WITH MAGNETIC CONNECTING PORT

(71) Applicant: Brooke Erin DeSantis, Montreal (CA)

(72) Inventors: Alain Desmeules, Montreal (CA); Julie Kassabian, Montreal (CA); Heloise Beique-Simmons, Montreal (CA); Martin Laberge, Montreal (CA)

(73) Assignee: Brooke Erin DeSantis, Montreal (CA)

(21) Appl. No.: 18/244,363

(22) Filed: Sep. 11, 2023

(51) Int. Cl. H02J 7/00; H01M 50/141; H01M 50/256

(52) U.S. Cl. CPC H02J 7/0045; H01M 50/141; H01M 50/256; H02J 7/0047; H01M 2220/30; H02J 2207/30

(57) ABSTRACT

A rechargeable portable dc battery is comprised of a waterproof battery casing defining a flat parallel front and rear wall and surrounding edge walls. The casing contains a substance capable of generating electrical current and to be recharged. A recessed magnetic electrical connecting port is disposed at a predetermined location in a top area of one of the front and rear walls and spaced adjacent a top one of the surrounding edge walls. The recessed magnetic electrical connecting port has an inwardly sloped guiding surrounding side wall leading to connector terminals in a bottom wall thereof. One or more magnets is disposed in the recessed magnetic electrical connecting port and electrically insulated from the connector terminals. The one or more magnets generate a magnetic coupling force for magnetic coupling with an external magnetically coupling electrical connector.

### FIELD OF INVENTION

The present invention relates to a rechargeable dc battery with a recessed magnetic electrical connecting port integrated with the battery casing and disposed for automatic magnetic coupling with a magnetic connector secured in a battery support pocket and wherein the connectors are automatically connected by magnetic attraction which also retains the dc battery captive. In a preferred, but not exclusive embodiment, the support pocket is that associated with a heated wearable.

### BACKGROUND OF THE INVENTION

Portable and rechargeable batteries are known for use in heated wearables and these are usually inserted in battery holding pockets associated with the heated wearables, such as a jacket, vest, pants, socks and gloves, etc. These pockets formed in the article of apparel have flaps or other means of retaining the battery captive and located for ease of access to permit replacement by a charged battery when depleted of its charge. Such dc batteries are provided with a power output port usually mounted on the top edge wall of the battery whereby to receive an electrical connector to feed current to electric heating circuit(s) permanently secured in the wearable. A control device is made accessible to the wearer person and is connected by a feed cables and connectors between the power output port of the battery and the electric heating circuit(s) to control the power fed to the electric heating circuit(s). These control devices are either permanently secured to the heated wearable or can be provided as an accessory which needs to be connected to connectors provided in the heated wearable, as mentioned above.

It would be advantageous to provide a rechargeable portable dc battery capable of overcoming the above-mentioned problems of wire connections of the know prior art heated wearables to connect and control battery supplies to heated circuits and to provide additional desirable features.

Rechargeable and portable dc batteries also need to be disconnected when they require charging. This is very inconvenient to the user person. Also, removed batteries being charged on a remote charger can sometimes be forgotten to be repositioned in the article of warmth, such as a jacket, with the wearer person dawning the article not aware that the heating feature is not operable. Further, interchanging a depleted battery in a cold climate environment and reconnection of a charged battery and connector can prove difficult. Control devices are usually provided with lights, which are mounted to be visible to the user person, to indicate that the battery(ies) is charged or indicate the remaining charge or if the battery is entirely depleted of its charge and requiring replacement with charged battery. Accordingly, the mounting position of the control device and the battery support pocket needs to provide visual access to the user person. Once the battery is depleted or if it is desirable to recharge it, the user person must disconnect the retention flap or other form of retention associated with the pocket, remove the battery connector, remove the battery from the pocket and install a charged battery. This is time consuming and permitting heat loss during cold weather conditions when the body is exposed to the elements.

It would be advantageous to provide a rechargeable dc battery and support pocket to simplify this assembly of parts and functions particularly the need for the user person having to secure or disconnect the battery output connector to a connector of a cable secured to electric heating circuits or a control device secured to a wearable or secured to other articles associated with different functions, such a medical or military applications.

There is also a need to provide quick replacement, ie “swapping of batteries”, when the wearable is in use and its battery need to be replaced with a charged battery and permitting such swapping with only one free hand. During cold weather conditions these simple tasks can sometimes prove difficult to manipulate the battery and the cable connections thereto, not to mention heat loss during this replacement process.

Another problem with current battery connections to the heating circuit or control devices is that the supply cable can become accidently disconnected by movements of the user person and the entanglement of the supply cable with the clothing. It is also important to secure these control devices and their batteries at locations which provide protection of the battery and its connections against bad weather conditions, such as rain or snow. It would therefore be advantageous to provide a totally waterproof rechargeable dc battery.

Still further, the installation of such control devices and its associated wiring requires extra care by the fabricator of such wearables with precise attachment of the wiring from the control device to the heating wires, to prevent the risk of the wiring becoming detached during use. Also, these control devices and connectors to the heating circuit(s) requires that the article of apparel can only be dry cleaned and during such dry-cleaning process damage may be caused to its wiring. Because these known control devices and their associated remote charging port and wiring form a bulky package, their application is somewhat limited to the type of heated wearable that can be equipped with such, and usually limited to installation on jackets, vests, or other large body garments. Their assembly is often not aesthetically pleasing to the eye.

Electrically heated socks, boots and gloves, for example, requires the fabrication of a small pocket directly on the article in which a small thin battery is contained and a connector for the battery supply. The pocket is usually closed by a zipper type closure to seal the pocket to protect the battery against water infiltration. Once the battery is depleted of its charge, the user person needs to disconnect the closure of the pocket, retrieve the battery from the pocket, which is usually small providing difficult access, and disconnect the battery form its connectors. The battery then requires to be connected to a charger if close-by. This process is then reversed to re-install a charged battery in its pocket. Such process requires frequent manipulation of the battery which will eventually cause wear and damage and sometimes loss due to its frequent removal. It would be advantageous to be able to recharge the battery without its removal for its holding pocket.

A still further disadvantage of current rechargeable and portable dc batteries is their configuration. These batteries are usually constructed of rectangular shape and mounted in pockets with their long axis extending vertically. The connectors are also bulky and project from the battery walls. A disadvantage of this battery shape and connectors, in heated articles of apparel, is that they often present a discomfort against the body of the wearer person and particularly when executing certain movements such as bending forward or when in a sitting position. There is therefore a need to provide a battery and connector(s) which overcomes this further disadvantage.

Another disadvantage of current rechargeable and portable dc batteries is that sometimes the supply wiring from the battery to the heating circuits becomes disconnected from the battery due to movements of the wearer person or a fall during an athletic sport activity, such as skiing. The battery can also be projected out of its support pocket. There is therefore another need to improve on the strength of such connection to reduce the risk of the battery being disconnected. There is also a need to provide a means to easily connect and disconnect the battery connector from its support pocket.

Known portable dc batteries for heated wearables only provide electrical power to the heated wearable. It would be desirable to also transfer data for the purpose of communication between the control device and the battery.

In summary it would be advantageous to provide an improved rechargeable dc battery capable of overcoming all of the above-mentioned problems of the known prior art and to provide additional desirable features.

### BRIEF SUMMARY OF THE INVENTION

It is therefore a feature of the present invention to provide a rechargeable dc battery which substantially overcome all of the above-mentioned disadvantages of the prior art rechargeable dc batteries.

A further feature of the present invention is to provide a waterproof rechargeable dc battery which has a recessed magnetic output power connecting port, and which does not require wire connection when placed in a support pocket where it automatically connects to a connector providing power to the heating wearable as well as retention of the battery in the support pocket.

Another feature of the present invention is to provide a rechargeable and portable dc battery which does not require manual connection of a cable to the heating wearable thereby eliminating the risk of damage to an exposed cable associated with the heating wearable.

A still further feature of the present invention is to provide a rechargeable and portable dc battery secured to an electrical connector mounted on a support harness provided with a pull tab and secured in a battery support pocket and wherein the battery output connector can also provide the recharging. The battery, in a further embodiment, is provided with a universal USB type C charging port which does not require specific visual orientation of the charging cable for connection to the battery.

A still further feature of the present invention is to provide a rechargeable dc battery which can be easily interchanged and reconnected to the electrical connector of the heating circuits, or other circuits containing data, without requiring visual access to the connector and finger manipulation of external connectors.

Another feature of the present invention is to provide a rechargeable and portable dc battery wherein the connector coupling thereof is affected automatically by the magnetic field intensity of opposed magnets, in the order of approximately 0.8 kg, and wherein the connectors can be separated from its magnetic force coupling by the use of a finger holding tab secured to the battery support pocket.

A further feature of the present invention is to provide a rechargeable and portable dc battery of square shape making the battery less encumbering when worn in a heated wearable, and wherein the battery can be charged without removal from the battery holding pocket of the heated wearable.

Another feature of the present invention is to provide a rechargeable dc battery having an output power port providing for connection to a cable having wiring for the transmission of electricity and data. Therefore, the battery output power port has multiple pins to be able not only to supply power the heated wearable but also to transfer data for the purpose of communicating information between the battery and the controller and/or sensors in the wearable, such as temperature sensors and proximity sensors, for example.

Another feature of the present invention is to provide a totally waterproof battery and connecting port(s) by eliminating openings such as a connecting port for a dc plug. Magnetic connections of the battery protect against water infiltration.

A still further feature of the present invention is to provide a magnetic connector assembly which is securable to a battery support pocket to automatically couple to the magnetic output connector of the battery and provide a strong magnetic coupling force to lock the battery in position and prevent it from movement and ejection from the pocket during the user's activities and securing the ability for continuous data communication and power connection between the battery to the heated system of the wearable.

Another feature of the present invention is to provide charging station with multiple magnetic charging ports to charge a pluralities of batteries of the present invention at the same time for multiple user applications of heating garment, such as at a police station, and for users to be able to quickly grab a fully charged battery with one hand and place the empty battery on the charging station rapidly and without fussing with a cable and a dc connector.

Another feature of the present invention is to provide a support pocket in the form of a battery holster and not to have the battery supported by the heated wearable but separately. For example, police are required to wear a bullet proof vest and the heated system would need to be in between the body (closer to the skin) and the bullet proof vest. Because the battery would not fit there, it would have to be in a separate location from the heated garment. One of the locations for the battery support could be on the belt of the pants or on top of the bullet proof vest. It could then be advantageous to have a separate battery holster equipped with the magnetic connector of the present invention for easy swap (exchange of batteries).

Another feature of the present invention is to provide the rechargeable dc battery with one or more vibrating devices to communicate certain information to the user person to the fingers and/or the skin/bones of the user person, such information being as an example the turning “on” or “off” of the system, various information from sensors, temperature settings, battery power, etc. The communications of the haptic/vibration system for each of the information and feedback transmitted is intuitive to the user or could be easily learned. The circuit board mounted in the battery could also have circuitry to provide BLUETOOTH, Registered Trademark, communication to transmit information to an app on an intelligent device of the user person to communicate information.

According to the above-mentioned features, from a broad aspect, the present invention provides a rechargeable portable dc battery is comprised of a waterproof battery casing defining a flat parallel front and rear wall and surrounding edge walls. The casing contains a substance capable of generating electrical current and to be recharged. A recessed magnetic electrical connecting port is disposed at a predetermined location in a top area of one of the front and rear walls and spaced adjacent a top one of the surrounding edge walls. The recessed magnetic electrical connecting port has an inwardly sloped guiding surrounding side wall leading to connector terminals in a bottom wall thereof. One or more magnets is disposed in the recessed magnetic electrical connecting port and electrically insulated from the connector terminals. The one or more magnets generate a magnetic coupling force for magnetic coupling with an external magnetically coupling electrical connector,

According to another broad aspect of the present invention there is further provided a magnetic electrical connector for securement in a dc battery support pocket. The magnetic electrical connector has a support harness formed of flexible non-electrically conductive material. The support harness also has a pull tab extending therefrom. The support harness is secured to a rear wall of the support pocket closely spaced from an accessible top end of the pocket. The pocket is sized to receive a portable dc battery therein with the dc battery having a magnetically coupling recessed electrical connecting port with connector terminals and disposed at a predetermined location in a top end portion thereof wherein when the dc battery is positioned in the pocket, with the protruding connector and recessed magnetic connecting port in close proximity to one another, they automatically couple together by the magnetic field intensity produced between the magnetic protruding connector and the recessed magnetic connecting port.

According to another broad aspect of the present invention there is provided a magnetically coupling electrical connector for connection to a recessed magnetic electrical connecting port of a rechargeable portable dc battery. The magnetically coupling electrical connector is formed with an electrically insulating support harness having a cable secured thereto. The cable has wires electrically insulated from one another for connection to electrical heating circuits secured in a heating wearable. An elongated electrically insulating ridge formation is secured to the support harness and defines an upwardly and inwardly sloped contour side wall leading to an elongated flat top face thereof. An elongated coupling rib of electrically insulating material is formed on the flat top face and concentrically positioned thereon. Electrical terminals are disposed spaced-apart on a flat top wall of the elongated coupling rib and a magnet is secured in the elongated flat top face of the elongated electrically insulating ridge formation.

According to a further broad aspect of the present invention there is provided a rechargeable portable dc battery for heating wearables. The battery has a flat waterproof casing defining opposed parallel front and rear walls and surrounding parallel edge walls. The casing contains a substance capable of generating electrical current and to be recharged. A recessed magnetic electrical charging port is secured in a top end region of the rear one of the opposed parallel front and rear walls for automatic coupling with an external magnetically coupling electrical connector immovably secured at a predetermined position in a top area of a battery support pocket of a heating wearable when said battery is positioned in the battery holding pocket with the recessed magnetic electrical connecting ort in substantially facial relationship with the magnetically coupling electrical connector. A charging port is mounted in a top one of the surrounding parallel edge walls.

### BRIEF DESCRIPTION OF THE DRAWINGS

The invention will now be described, by way of example, with reference to the accompanying drawings in which:

FIG. 1 is a perspective view of the rechargeable portable dc battery viewed from the rear wall thereof illustrating the recessed magnetic electrical connecting port of the battery as well as the auxiliary electrical components mounted in a top edge wall of the battery;

FIG. 2 is a front perspective view of the magnetic coupling connector for securement to the connecting port of the battery;

FIG. 3 is a rear perspective view of the magnetic coupling connector;

FIG. 4 is a side view, partly fragmented showing the magnetic coupling connector magnetically and electrically coupled to the magnetic recessed electrical connecting port of the battery;

FIG. 5 is a perspective and fragmented top end view of a battery support pocket of a heating wearable showing the position of the magnetic coupling connector secured therein the position thereof in the pocket for coupling with the magnetic recessed electrical connecting port of the battery;

FIG. 6 is a perspective and fragmented top view of the battery holding pocket similar to FIG. 5 and illustrating the position of the battery in the battery holding pocket with the magnetic connectors engaged and showing the pull tab of the support harness of the magnetic coupling connector extending above the top edge wall of the battery;

FIG. 7 is a perspective view illustrating how the engaged connectors are separated from each other for the removal of the battery from the battery support pocket;

FIG. 8 is an enlarged perspective view showing the construction of the magnetic coupling connector mounted on the support harness formed of flexible material;

FIG. 9 is an explosive perspective view of FIG. 8;

FIG. 10 is an explosive perspective view of the component parts of the magnetic recessed electrical connecting port forming part of the battery structure,

FIG. 11 is an explosive perspective view showing another embodiment of the construction of the magnetic coupling connector of FIG. 9;

FIG. 12 is a perspective view of the rectangular magnetically coupling electrical connector formed in a top end area of the rechargeable portable dc battery illustrating another embodiment wherein the connector terminals are formed by pin connectors,

FIG. 13 is an exploded perspective view illustrating the coupling alignment of the recessed electrical connecting port of the battery to the external magnetically coupling electrical connector;

FIG. 14 is a cross sectional view showing the battery recessed electrical connector secured to the external connector and illustrating a portion of the top end of the battery and the position of a circuit board secured above the battery cell in the seal waterproof housing of the dc battery;

FIG. 15 is a perspective view of a holster-type battery support pocket shown with a body attachment harness for support by the body of a wearer person for monitoring a sensor device attached to the body of a wearer person, and

FIG. 16 is a fragmented perspective view of the holder type batter support pocket shown having a belt clip secured thereto to support by a pant belt of a wearer person.

### DETAILED DESCRIPTION OF THE INVENTION

Before any embodiments of the application are explained in detail, it is to be understood that the application is not limited to the details of construction and the arrangement of component part set forth in the following description or illustrated by the drawings. Further, it is to be understood that the phraseology and terminology used herein is for the purpose of description and should not be regarded as limiting but should encompass equivalents thereof.

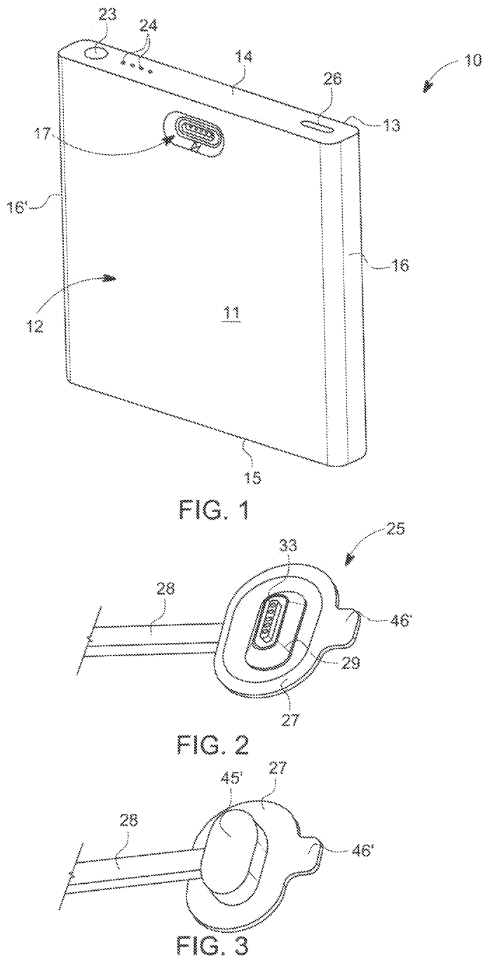

Referring now to the drawings, and more specifically to FIGS. 1, 2 and 5, there is shown generally at 10 the rechargeable portable dc battery of the present invention specifically designed for retention and securement to a magnetically coupling electrical connector 25 mounted in a battery support pocket 50 of a heated wearable, as will be described in more detail herein below. The battery 10 comprises a sealed waterproof battery casing 11 defining opposed parallel front and rear walls, 13 and 12, respectively, and surrounding edge walls, herein a top edge wall 14, a bottom edge wall 15 and opposed side edge walls 16 and 16′. The casing 11 contains a substance in the form of a rechargeable cell(s) capable of generating electrical current and to be recharged, as obvious to a person skilled in the art.

With further reference to FIG. 10, it can be seen that the rechargeable dc battery is constructed with a recessed electrical connecting port 17 which is mounted at a predetermined location in a top end area of the rear wall 12 spaced adjacent the top edge wall 14. As can be seen, and with further reference to FIG. 10, the recessed electrical connecting port 17 is of elongated rectangular configuration and defines opposed outwardly curved end walls 18, 18′ and opposed elongated side walls 18″. The sidewalls and end walls are downwardly and inwardly slopped walls leading to connector terminals 19 mounted in a flat elongated bottom wall 20. The flat elongated bottom wall 20 is constituted by the top face of an elongated support base member 21 formed of electrically insulating material.

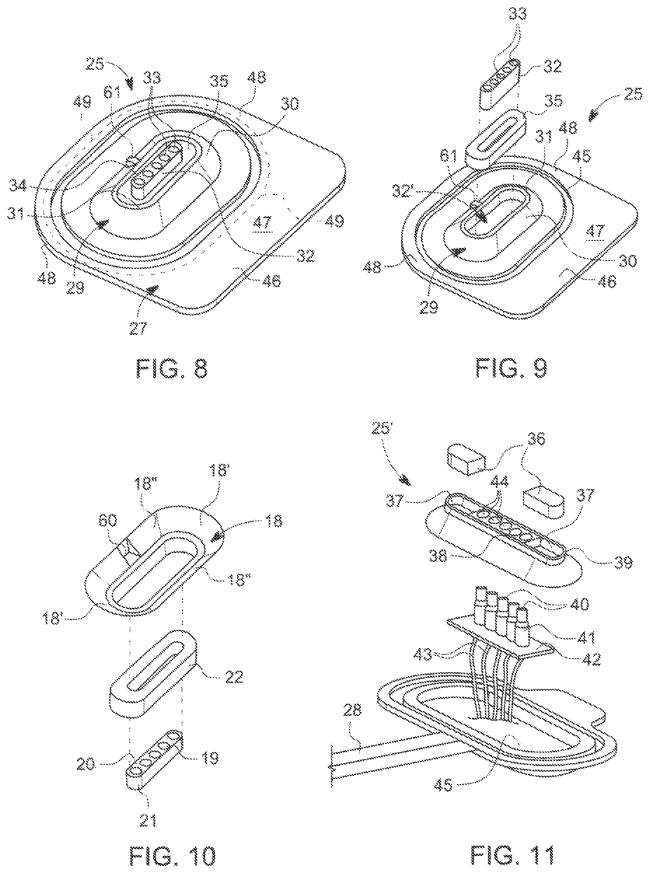

Magnetic retention means, in the form of an elongated ring-shaped magnet 22 is retained about the elongated support base 21 and electrically insulated from the connector terminals 19 by the non-electrically conducting material of the elongated support base 21. The construction of the recessed electrical connecting port 17 is specifically adapted for retaining, by magnetic attraction force, the external magnetically coupling electrical connector 25, 25′ as illustrated herein, in FIGS. 8, 9 and 11, and which is adapted to be connected to one or more electrically conductive heating circuits. The heating circuits may be in the form of heating pads or heating wiring sewn in defined areas of a device or garment to provide heat, not shown but obvious to a person skilled in the art. In the case of a heating wearable, the heating circuit can be integrated in a jacket, a vest, pants, gloves, socks, as examples but not limited thereto. Other applications of the battery and the external magnetically coupling electrical connector 25 is contemplated.

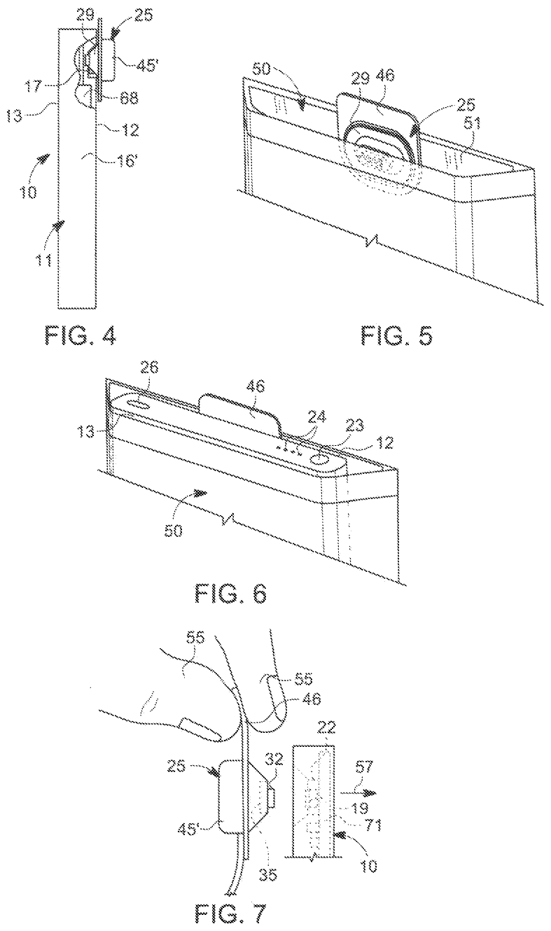

As illustrated in FIGS. 1 and 4, the battery casing 11 is a square flat casing with the surrounding edge walls being opposed parallel edge walls. A square casing is found to provide more comfort against the body of a wearer person. Commonly, dc batteries for use with heating wearables are long rectangular batteries disposed vertically in battery support pockets of wearables with a pin connector located in a top wall for receiving a connector secured to a control device secured to heating electrical circuits mounted in the wearable. A disadvantage of such rectangular shape battery and its support pocket in a heated wearable is that they often are a nuisance to the wearer person when assuming certain positions and movements, such forward bending movements when one or more batteries are supported in a chest area of the wearer person, particular when in a sitting position and bending forward. By constructing the battery with a square form such a disadvantage is substantially overcome. Another advantage of the square shape of the battery is that it liberates vertical space on the article of apparel for other uses.

As shown in FIG. 1, the top edge wall 14 of the battery 10 has a push-button switch 23 mounted thereon with associated visual functional display means in the form of LED lights 24, to inform the wearer person of the charged state of the battery. By actuating the switch 23 the lights are turned “on” to indicate the charge state of the battery. Re-actuating the switch 23 turns the lights “off”.

As also illustrated in FIG. 1, a USB charging port 26 is also mounted on the top edge wall 14. The charging port is a USB type C port which is now a universal port adapted around the world to receive connectors to various electronic devices. This type of port does not require visual orientation of the charging connector for securement as the connector can be engaged in the port from either side, as is well known in the art. A further advantage of the charging port, in combination with the recessed electrical output connecting port 17, is that the battery 10 can be charged without having to remove the battery from its battery retention pocket, either when worn by a wearer person or when the article of apparel is not in use.

In a further embodiment, the recessed electrical output connecting port 17 is wired to receive a magnetically coupling electrical connector similar to the connector 25 but connected to the output of an electrical charger or a portable charging battery. With such embodiment there would not be the need for the USPC charging port in the top edge wall 14 of the battery. If the charger is a portable charging battery it could also be connected to the dc battery 10 supported in the wearable or its support pocket. It is also contemplated that for an application where there are many service people such as police or military personnel, wearing heated wearables or have the need to have a wearable to support a battery to provide power to specific devices, such as communication devices (cell phones), the charging of the batteries can be in the form of a long bank of chargers having magnetic connectors where such service personnel would interchange their batteries after use with fully charged batteries attached to the bank of chargers. This would be done quickly by swapping batteries.

Referring now to FIGS. 2, 3, 8 and 9 there is described the construction of the magnetically coupling electrical connector 25. As illustrated, the magnetically coupling electrical connector 25 is secured to an electrically insulating support harness 27 constructed of flexible material capable of being secured in a support pocket of an article of apparel or holster support associated with other articles requiring power or other devices such as sensors, medical monitoring devices, etc. A cable 28, with wires therein, connect to the terminals 33 of the connector 25 and to electrical heating circuits secured in a heating wearable or to a control device, not shown. The magnetically coupling electrical connector 25 is formed with an elongated electrically insulating oval-like shaped ridge formation 29 secured to the support harness 27 and defines an upwardly and inwardly sloped contour side wall 30 leading to an elongated narrow flat top face 31 surrounding a central cavity 32′ thereof. An elongated coupling rib 32 of electrically insulating material is shaped to be disposed in the central cavity 32′ of the oval-like ridge formation 29 and secured on a support board, not shown for connection to the wiring in the cable 28, such as shown in FIG. 11. Electrical terminals 33 are disposed spaced-apart in a flat top wall 34 of the elongated coupling rib 32 and positioned for electrical contact with associated ones of the connector terminals 19 of the recessed electrical connecting port 17 of the rechargeable portable dc battery 10. The harness 27 is formed of polymeric resinous material which seals the component part to the harness 27 and makes it waterproof.

Magnetic coupling means in the form a ring-shaped magnet 35 is disposed about the coupling rib 32 and together form a tight fit inside the central cavity 32′. The magnet 35 is selected to provide a magnetic adhesion force, which together with the ring shaped magnet 22 of the recessed electrical connecting port 22 of the battery 10, produces a coupling magnetic retention force in the order of approximately 0.8 kg, sufficient to pull the magnetically coupling electrical connector 25 in coupling alignment and engagement in recessed electrical connecting port 17 and with the connectors 33 in conductive engagement with the connectors 19.

FIG. 11 shows another embodiment of the magnetically coupling electrical connector, herein connector 25′, wherein the magnetic coupling force is generated by disc-shape magnets 36 secured in retention cavities 37 formed in a flat top wall 38 of an elongated coupling ridge formation 39. The elongated coupling ridge formation 39 is formed of electrically insulating material. Electrical terminals 40 are disposed spaced-apart on the flat top wall 38 of the elongated coupling ridge formation 39 and are constituted by metal pin connectors 41 secured to a support connecting board 42, and to which individual ones of the wires 43 of the cable 28 are connected to. The cable 28 is a woven cable of flat shape to provide comfort when connected in a wearable containing the support pocket 50. The elongated electrically insulating coupling ridge formation 39 has though holes 44 formed in the flat top wall 38 for receiving respective ones of the metal pin connectors 41 in close fit therein with the flat top face thereof constituting the terminals 40. As herein shown, there are five of the metal pin connectors 41 with two of the pin connectors for the transmission of power from the positive and negative terminal connections of the battery and three of the pin connectors for the transmission of communication data from circuits mounted on the pcb (printed circuit board), as shown in FIG. 14.

With reference now to FIGS. 3, 8, 9 and 11, the electrically insulating support harness 27 is shaped to define an elongated open top end cavity 45 for receiving therein the electrically insulating ridge formation 30, the ring-shaped magnet 35 and the rib 32. The cavity 45 is dimensioned to form a housing 45′ projecting behind the support harness 27 for receiving the cable 28 and its connection as well as a circuit board 71 containing electronic components and wiring, see FIG. 14, associated with the push-button switch 23, the LED lights 24 and other associated electrical features. For example, a haptic component could be mounted on the pcb board to provide pulsating signals against the body of the wearer person to transmit signals which represent the “on” or “off” state of the battery, sensor information, temperature settings, etc. The communication of the haptic or vibration signals for each of this type of information/feedback is intuitive to the user person or could be easily learned.

A pull tab 46 is formed integral with the electrically insulating support harness 27 by an extension section 47 of the polymeric resinous harness and disposed in a top portion of the support harness. The support harness 27 is also shaped to define a stitch allocation seam 48 spaced outwardly about the elongated cavity 46 for receiving thread stitches 49 therein for its attachment to a support pocket, holster, etc. FIG. 8 shows the pull tab extending the full width of the support harness 27, whereas FIGS. 2 and 3 show the pull tab 46′ as a narrow central extension band of the support harness.

As illustrated in FIGS. 4 to 6, the electrically insulating support harness 27 is secured to a rear fabric wall 51 of a battery holding pocket 50 of a heated wearable, not shown, but obvious to a person skilled in the art. The electrically insulating support harness 27 is secured in a top end 52 of the battery holding pocket 50 with the pull tab 46 projecting above the pocket top end wherein when the battery 10 is disposed in the pocket with the connectors magnetically coupled, the pull tab projects behind and above the battery top edge wall 14, as shown in FIG. 6 for access thereof. It is pointed out that when the dc battery 10 is positioned in the pocket 50 with the protruding connector 25 and recessed connector 17 in close proximity to one another, the protruding magnetic connector 25 with its strong magnet 35 and the strong magnet 22 of the battery connector with opposed polarity will magnetically attract each other, by the combined magnetic field intensity produced between the magnetic protruding connector and the magnetically coupling recessed connector, to pull each other in coupling relationship and automatically establish electrical connections therebetween. The battery holding pocket 50 can have many functions to support a battery associated with other heating products, such as a blanket, a sleeping bag, etc. and other electrical devices requiring dc power from a rechargeable dc battery. The battery holding pocket provides for a quick connection and disconnection of the battery in the pocket to swap batteries. This is particularly useful to a person performing busy activities, such as a police directing traffic or military personnel performing difficult tasks. The magnetic connection produces a retention force to safely retain the battery in its holding pocket, eliminating the risk of the battery falling out due to motions of the wearer person, such as when bending forward, falling, etc.

As shown in FIGS. 8 and 10, on order to insure proper alignment of the connectors when the battery is disposed in the pocket 50, the magnetic electrical connector 17 may be formed with an alignment formation 60 in its downwardly and inwardly slopped surrounding side wall 18 and shaped for receiving a guide rib 61 of the external magnetically coupling electrical connector 25 whereby to provide a foolproof coupling. As herein shown, the coupling connector aligning formation 60 is constituted by a straight notch forming a rectangular cavity 62 at a predetermined position in the downwardly and inwardly slopped surrounding side wall 18. The notch forms an open end in the outer surface of the downwardly and inwardly slopped surrounding side wall to receive, in loose fit therein, the guide rib 61 formed in the slopped guide wall of the external magnetically coupling electrical connector and dimensioned for close sliding fit in the rectangular cavity.

Because of the strong magnetic coupling of the connectors, the pull tab 46 provides for separation of the magnetic coupling force. To separate the connectors, the user person grasps the tab 46 between its fingers 55, as shown in FIG. 7, while holding the battery between the finger of the other hand and exert a separating force, in the direction of arrows 56 and 57 to overcome the magnetic coupling force to disconnect the protruding magnetic connector 25 from the recess connector 17 of the dc battery 10 and overcoming the strong magnetic field intensity, in the order of approximately 0.8 kg, as mentioned herein above.

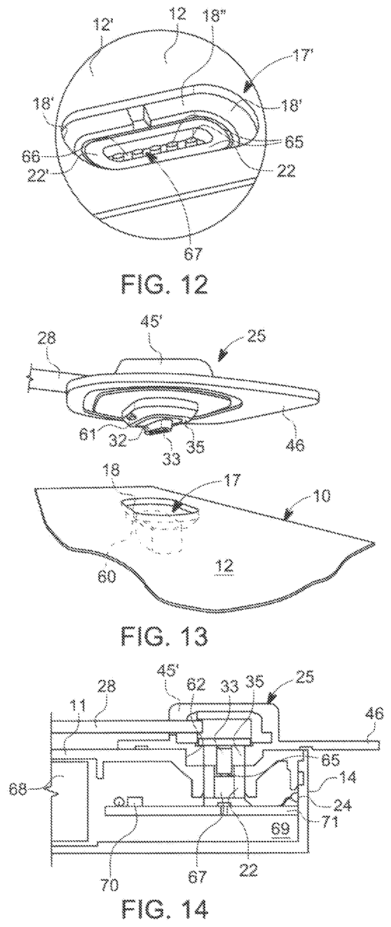

Referring now to FIGS. 12 to 14, there is shown a preferred construction of the recessed magnetic connector 17′ of the dc battery 10. As shown in FIG. 12 the inwardly slopped surrounding side wall 18 of the recessed magnetic connecting port 17′ is slightly recessed from the surface 12′ of the rear wall 12 of the battery and leads to the connectors, which are herein illustrated as being formed as pin connectors 65 projecting from a top face 66 of an elongated support base 67 mounted on the printed circuit board 71. The pin connectors 65 are recessed from the top face 22′ of the surrounding ring-shaped magnet 22. The pin connectors 65 are shaped similarly to the pin connectors illustrated in FIG. 11 and connected to wires 43 as previously described.

As shown in FIG. 14, a circuit board 71 is mounted in a pcb mounting space 69 defined in a top end portion of the battery casing 11 behind the top edge wall 14 and above the battery cell 68. The base portion of the connector pins 65 is connected to terminals of the printed circuit board (not shown) to establish connection to associated wiring connected to the positive and negative terminals of the battery and other connections to the switch 23 and LED lights 24 mounted on the top edge wall 14. The circuit board 71 may also contain electronic components 70 associated with functions provided to the battery.

FIG. 13 illustrates the coupling alignment of the recessed magnetic connector of the battery and the external magnetic connector 25. Once the battery is inserted into the holding pocket 50 or holster pocket, as shown in FIGS. 5 and 6, the connectors are in close proximity to one another by the shape and size of the pocket or by manipulation and alignment by the wearer person and the strong magnetic field produce between the magnets take over and draw the connectors in aligned coupling engagement.

The coupling of the connectors 65 and 33 is achieved by the inwardly slopped surrounding side wall 18 of the recessed connector in sliding contact with the slopped contour side wall 30 of the connector 25 in guiding sliding fit with one another. Also, the rib 61 of connector 25 entering the guide notch 62 of the recessed connector of the battery assures that proper alignment is achieved as the strong magnetic attraction of the magnets pull the connectors together in position. To ensure that the connectors have been engaged, the user person presses the push-button switch 23 on the top edge wall of the battery to see if an LED light 24 is lit and if not, due to misalignment, the user person simply grasps the battery with one hand and moves it slightly over the connector 25 until it clicks into engagement and the lights lit to display the charge. The switch is again depressed to switch the LED's “off”. To further prevent misalignment of the connectors when the battery is positioned in the battery holding pocket 50, as shown in FIGS. 5 and 6, the pocket is sized for close fit of the battery therein whereby the connectors 17 and 25 lie in substantially facial relationship.

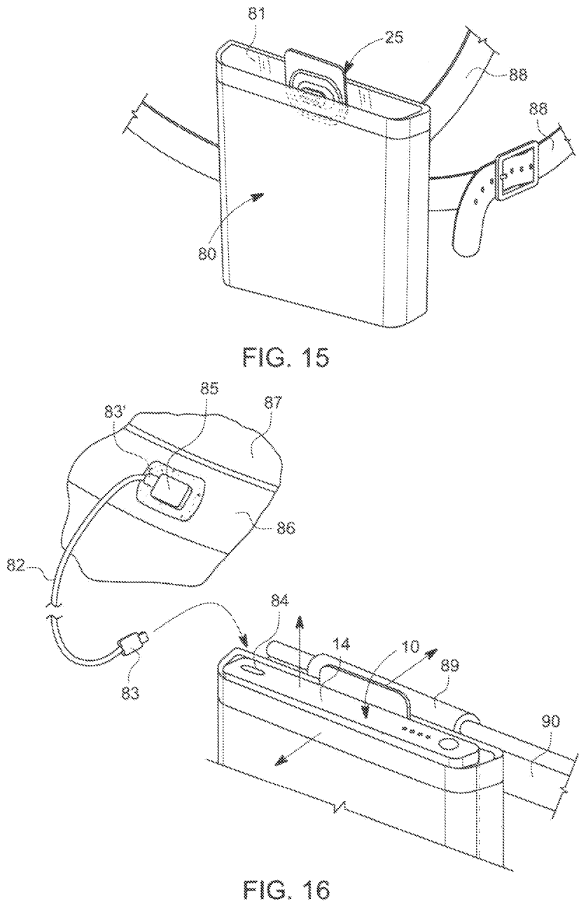

With reference now to FIGS. 15 and 16, there is shown the battery support pocket formed as a holster-type battery support pocket 80 dimensioned for receiving the rechargeable battery 10 in close fit therein to effect the automatic coupling of the connectors by magnetic attraction, as described herein above. The magnetically coupling electrical connector 25 is secured to the rear wall 81 of the holster-type battery support 80 by stitching or other suitable attachment means. As shown in FIG. 16, an output power cable 82 is provided with USBC connectors 83 and 83′ at respective ones of opposed ends thereof to connect with an output USBC port 84, provided on the top edge wall 14 of the battery 10, and to an external device, herein a sensor device 85 secured to a strapping 86 attached to the body 87 of a wearer person to monitor heartbeat and temperature.

The output power cable 82 can connect to various other type devices when worn by service personnel, such as police and military people. The holster-type battery support pocket 80 is provided with attachment means in the form of a body harness 88 as shown in FIG. 15 for support by the body of a wearer person or a belt clip 89, as shown in FIG. 16, for attachment to a pant's belt 90. As mentioned above, the dc battery could also be provided with a BLUETOOTH protocol to transmit information received by the cable 82 to a portable smart phone having an apt to store and display the signal information received through the cable and its connectors which are provided with terminals and wiring to conduct power and data.

It is pointed out that any modifications and other embodiments of the present invention as described above will come to mind to a person skilled in the art to which the invention pertains having the benefit of the teachings described herein above and the drawings. Hence, it is to be understood that the embodiments of the present invention are not to be limited to the specific examples thereof as described herein and other embodiments are intended to be included within the scope of the present invention and the appended claims. Although the foregoing descriptions and associated drawings describe example embodiments in the context of certain examples of the elements and members and/or functions, it should be understood that different combinations of elements or substitutes and/or functions may be provided by different embodiments without departing from the scope of the present invention as defined by the appended claims. Furthermore, although specific terms are employed herein, they are used in a generic and descriptive sense only and other equivalent terms are contemplated herein with respect to the items that they relate to. It is therefore within the ambit of the resent invention to encompass all obvious modifications of the examples of the preferred embodiment described herein provide such modifications fall within the scope of the appended claims.

1. A rechargeable portable dc battery comprising a battery casing defining a flat parallel front and rear wall and surrounding edge walls, said casing containing a substance capable of generating electrical current and to be recharged, a recessed magnetic electrical connecting port disposed at a predetermined location in a top area of one of said front and rear walls spaced adjacent a top one of said surrounding edge walls, said recessed magnetic electrical connecting port having an inwardly sloped guiding surrounding side wall leading to connector terminals in a bottom wall thereof, and one or more magnets disposed in said recessed magnetic electrical connecting port and electrically insulated from said connector terminals, said one or more magnets generating a magnetic coupling force for magnetic coupling with an external magnetically coupling electrical connector.

2. The rechargeable portable dc battery as claimed in claim 1 wherein said recessed magnetic electrical connecting port is an output power port, said surrounding side wall being a guiding surrounding side wall having a downwardly and inwardly sloped circumferential surface.

3. The rechargeable portable dc battery as claimed in claim 1 wherein said external magnetically coupling electrical connector is immovably secured at a predetermined position in a battery support pocket associated with an article requiring dc power, said dc battery being disposed in said battery support pocket with said recessed magnetic electrical connecting port in facial relationship with a projecting electrical connector of said external magnetically coupling electrical connector wherein said connector automatically electrically couple and lock together by magnetic attraction preventing said dc battery from accidentally falling out of said battery support pocket.

4. The rechargeable portable dc battery as claimed in claim 1 wherein said recessed magnetic electrical connecting port is of elongated rectangular shape and defining opposed outwardly curved end walls, said bottom wall being a flat bottom wall constituted by a top wall of an elongated support base member to which is secured said connector terminals.

5. The rechargeable portable dc battery as claimed in claim 4 wherein said one or more magnets of said recessed magnetic electrical connecting port is constituted by a single surrounding magnet retained about said elongated support base and electrically insulated from said connector terminals by said elongated support base.

6. The rechargeable portable dc battery as claimed in claim 4 wherein said connector terminals have a flat top face and held disposed equidistantly space form one another in said flat top wall of said bottom elongated support base.

7. The rechargeable portable dc battery as claimed in claim 5 wherein said surrounding magnet when magnetically coupled to said magnet of opposed polarity of said external magnetically coupling electrical connector produces a magnetic adhesion force of approximately 0.8 kg.

8. The rechargeable portable dc battery as claimed in claim 1 wherein said battery is constituted by a waterproof flat casing with said surrounding edge walls being opposed parallel edge walls defining a top wall, a bottom wall and opposed parallel side walls.

9. The rechargeable portable dc battery as claimed in claim 8 wherein said top one of said surrounding edge walls has a push-button switch and visual charge display lights mounted therein to indicate the charge present in the dc battery

10. The rechargeable portable dc battery as claimed in claim 9 wherein a USB charging port is further provided in said top one of said surrounding edge walls.

11. The rechargeable portable dc battery as claimed in claim 1 wherein said magnetically coupling electrical connector is secured in a predetermined position in a battery support pocket of a heating wearable to receive said rechargeable dc battery therein with said recessed magnetic electrical connecting port facing said magnetically coupling electrical connector for magnetic coupling thereof by magnetic attraction

12. The rechargeable portable dc battery a claimed in claim 11 wherein said magnetically coupling electrical connector is secured to an electrically insulating support harness, said support harness being secured to said battery support pocket and connected to wires housed in a cable leading to electrical heating circuits secured in said heating wearable.

13. The rechargeable portable dc battery as claimed in claim 12 wherein an elongated electrically insulating ridge formation is secured to said support harness and having an upwardly and inwardly sloped contour side wall leading to an elongated flat top face thereof, an elongated coupling rib of electrically insulating material on said flat top face and concentrically positioned thereon, electrical terminals disposed spaced-apart on a flat top wall of said elongated coupling rib and disposed for electrical contact with associated ones of said connector terminals of said recessed magnetic electrical connecting port of said rechargeable portable dc battery, one or more magnets of opposed polarity secured in said elongated flat top face of said elongated electrically insulating ridge formation for magnetic coupling with said one or more magnets of said recessed electrical connecting port of said rechargeable portable dc battery when said magnetically coupling electrical connector is received in said recessed electrical connecting port and electrically coupled by magnetic attraction.

14. The rechargeable portable dc battery as claimed in claim 13 wherein said surrounding magnet is an oval-shaped disposed about said coupling rib and providing a magnetic attraction force sufficient to create a coupling magnetic field to pull said recessed magnetic electrical connecting port by magnetic attraction for electrical coupling therewith, said magnetic attraction force preventing said battery from accidently fall out of said support pocket buy a wearer person's movements.

15. The rechargeable portable dc battery as claimed in claim 14 wherein said oval-shape magnet is secured in said flat top wall of said bottom elongated support base at opposed ends thereof and electrically insulated from said connector terminals by said support base.

16. The rechargeable portable dc battery as claimed in claim 14 wherein said electrically insulating support harness is formed of polymeric resinous material and shaped to define an elongated open top end cavity for receiving therein said electrically insulating ridge formation and said oval-shaped magnet, a pull tab formed integral with said electrically insulating support harness by an extension section of said polymeric resinous material and disposed in a top portion of said support harness.

17. The rechargeable portable dc battery as claimed in claim 13 wherein a coupling connector aligning formation is provided in said surrounding side wall of said recessed magnetic electrical connecting port and shaped for receiving a guide rib formed in said contour side wall of said magnetically coupling electrical connector by magnetic attraction to provide a foolproof coupling.

18. The rechargeable portable dc battery as claimed in claim 17 wherein said coupling connector aligning formation is constituted by a notch formed at a predetermined position in said downwardly and inwardly slopped surrounding side wall, said notch having an open end in an outer surface of said downwardly and inwardly slopped surrounding side wall.

19. The rechargeable portable dc battery as claimed in claim 17 wherein said guide rib is formed in a slopped guide wall of said external magnetically coupling electrical connector and dimensioned for close sliding fit in said surrounding side wall of said recessed magnetic electrical connecting port.

20. The rechargeable portable dc battery as claimed in claim 16 wherein said electrical terminals disposed spaced-apart on said flat top wall of said elongated coupling rib are constituted by metal pin connectors secured to a support base and to which individual ones of said wires are connected, said wires being retained in a flat cable secured in said cavity, said elongated electrically insulating ridge formation having though holes formed in said flat top face for receiving respective ones of said metal pin connectors in close fit therein.

21. The rechargeable portable dc battery as claimed 20 wherein there are five of said metal pin connectors with two of said pin connectors for the transmission of electrical power and three of said pin connectors for the transmission of communication data.

22. The rechargeable portable dc battery as claimed in claim 16 wherein said support harness defines a stitch allocation seam area spaced about said elongated cavity for receiving thread stitches therein for securing said magnetically coupling electrical connector to a rear wall of a battery holding pocket with said pull tab accessible from a top end of said battery holding pocket.

23. The rechargeable portable dc battery as claimed in claim 2 wherein said output power port is also a charging port for connection to a charger provided with a magnetically coupling electrical connector.

24. The rechargeable portable dc battery as claimed in claim 23 wherein a top one of said surrounding edge walls has a push-button switch and visual charge display lights mounted therein to indicate the charge present in the dc battery.

25. The rechargeable portable dc battery as claimed in claim 3 wherein said battery support pocket is a holster-type battery support pocket shaped for receiving said dc battery in close contact therein, said external magnetically connecting port being immovable secured to a rear wall of said holster-type battery support, and an output power cable connected to said external magnetically connecting port to provide power to one or more devices associated with said holster.

26. The rechargeable portable dc battery as claimed in claim 25 wherein said holster-type battery support pocket is provided with attachment means to attach said holster-type battery support pocket to the body of a wearer person.

27. The rechargeable portable dc battery as claimed in claim 26 wherein said attachment means is one of a body harness and a belt clip for support of said holster-type battery support pocket by the body of a wearer person.

28. A magnetic electrical connector for securement in a dc battery support pocket, said magnetic connector having a support harness formed of flexible non-electrically conductive material, said support harness having a pull tab extending therefrom, said support harness being secured to a rear wall of said support pocket closely spaced from an accessible top end of said pocket, said pocket being sized to receive a portable dc battery therein with said dc battery having a magnetically coupling recessed electrical connecting port with connector terminals and disposed at a predetermined location in a top end portion thereof wherein when said dc battery is positioned in said pocket with said protruding connector and recessed magnetic connecting port in close proximity to one another to automatically couple together by the magnetic field intensity produced between said magnetic protruding connector and said recessed magnetic connecting port.

29. The magnetic electrical connector as claimed in claim 28 wherein said pocket is formed in a heating wearable, said heating wearable being one of a jacket, a vest, a pants, a glove and a sock.

30. The magnetic electrical connector as claimed in claim 28 wherein said pocket is formed by a holster having attachment means for retention by a wearer person or an article requiring power or a support associated with an article requiring power.

31. The magnetic electrical connector as claimed in claim 28 wherein said pull tab defines a finger gripping area to permit a user person to grasp said pull tab between its fingers to exert a separating force with said battery to disconnect said protruding magnetic connector from said recess connector of said dc battery, said magnetic field intensity generating a coupling magnetic force in the order of approximately 0.8 kg.

32. The magnetic electrical connector as claimed in claim 28 wherein said support harness defines a stitch seam outer area spaced about said elongated cavity for receiving thread stitches therein for securing said magnetically coupling electrical connector to a rear wall of said battery support pocket with said pull tab accessible from a top end of said battery support pocket.

33. The magnetic electrical connector as claimed in claim 25 wherein said magnetic electrical connector is formed by an elongated electrically insulating ridge formation secured and projecting from said support harness and defining an upwardly and inwardly sloped contour side wall leading to an elongated flat top face thereof, an elongated coupling rib of electrically insulating material extending on said flat top face and concentrically positioned thereon, electrical terminals disposed spaced-apart on a flat top wall of said elongated coupling rib and disposed for electrical contact with associated ones of connector terminals of said recessed magnetic electrical connecting port of said rechargeable portable dc battery, one or more magnets secured in said elongated flat top face of said elongated electrically insulating ridge formation for magnetic coupling retention with a magnet of said recessed magnetic electrical connecting port of said rechargeable portable dc battery when said magnetically coupling electrical connector is received therein and self aligned and electrically coupled by said magnetic field intensity drawing said electrical terminals in contact with said connector terminals of said magnetically coupling recessed electrical connecting port, said one or more magnets and said magnet of said recessed magnetic electrical connecting port being disposed for facial contact by poles of opposed polarity.

34. The magnetic electrical connector as claimed in claim 33 wherein said one or more magnets is constituted by a surrounding magnet disposed about said coupling rib and providing a magnetic adhesion force sufficient to pull said magnetically coupling electrical connector in coupling alignment and engagement in said recessed magnetic electrical connecting port.

35. The magnetic electrical connector as claimed in claim 33 wherein said magnetic coupling means is constituted by a magnet secured in said flat top wall of said bottom elongated support base at opposed ends thereof and electrically insulated from said connector terminals by said support base.

36. The magnetic electrical connector as claimed in claim 33 wherein said electrical terminals disposed spaced-apart on said flat top wall of said elongated coupling rib are constituted by metal pin connectors secured to a support base and to which individual ones of said wires are connected, said wires being retained in a flat cable secured in said cavity, said cavity being waterproofed by said polymeric resinous material of said support harness, said elongated electrically insulating ridge formation having though holes formed in said flat top face for receiving respective ones of said metal pin connectors in close fit therein.

37. The magnetic electrical connector as claimed in claim 33 wherein said support harness is shaped to define an elongated open top end cavity for receiving therein said electrically insulating ridge formation and said surrounding magnet, a pull tab formed Integral with said electrically insulating support platform by an extension section of said polymeric resinous material and disposed in a top portion of said support platform.

38. A magnetically coupling electrical connector for coupling connection to a recessed magnetic electrical connecting port of a rechargeable portable dc battery, comprising an electrically insulating support harness, a cable secured to said harness and having wires electrically insulated from one another in said cable to provide power to electrical heating circuits secured in a heating wearable, an elongated electrically insulating ridge formation secured to said support harness and having an upwardly and inwardly sloped contour side wall leading to an elongated flat top face thereof, an elongated coupling rib of electrically insulating material on said flat top face and concentrically positioned thereon, electrical terminals disposed spaced-apart on a flat top wall of said elongated coupling rib and a magnet secured in said elongated flat top face of said elongated electrically insulating ridge formation.

39. The magnetically coupling electrical connector as claimed in claim 38 wherein said magnet is constituted by an oval-shaped magnet disposed about said coupling rib for magnetic coupling with a magnetic of said recessed magnetic electrical connecting port of said rechargeable portable dc battery when said magnetically coupling electrical connector is magnetically and automatically attracted in said recessed magnetic electrical connecting port of said portable chargeable dc battery and electrically coupled by magnetic attraction.

40. The magnetically coupling electrical connector as claimed in claim 39 wherein said electrically insulating support harness is formed of polymeric resinous material and a pull tab formed integral with said electrically insulating support harness by an extension section of said polymeric resinous material and disposed in a top portion of said support harness.

41. The magnetically coupling electrical connector as claimed in claim 40 wherein said support harness is shaped to define an elongated open top end cavity for receiving therein said electrically insulating ridge formation and said oval-shaped magnet, an outer stitch allocation seam area spaced about said elongated cavity for receiving thread stitches therein for securing said magnetically coupling electrical connector to a rear wall of a battery holding pocket with said pull tab accessible from a top end of said battery holding pocket above a top wall of a dc battery supported therein.

42. A rechargeable portable dc battery for heating wearables comprising a flat waterproof battery casing defining opposed parallel front and rear walls and surrounding parallel edge walls, said casing containing a substance capable of generating electrical current and to be recharged, and a recessed magnetic electrical connecting port in a top end region of said rear one of said opposed parallel front and rear walls for automatic coupling with an external magnetically coupling electrical connector immovably secured at a predetermined position in a top area of a battery support pocket of a heated wearable when said battery is positioned in said battery support pocket with said recessed magnetic electrical connecting port in substantially facial relationship with said magnetically coupling electrical connector, and a charging port mounted in a top one of said surrounding parallel edge walls.

43. The rechargeable portable dc battery as claimed in claim 42 wherein a push-button switch and visual actual battery charge display lights are mounted on said top one of said surrounding parallel edge walls.

44. The rechargeable portable dc battery as claimed in claim 42 wherein said charging port is a USB type C charging port.

45. The rechargeable portable dc battery as claimed in claim 42 wherein said recessed magnetic connecting port has a downwardly and inwardly slopped surrounding side wall leading to connector terminals in a flat bottom wall thereof, and a magnet disposed electrically insulated from said connector terminals for retaining by magnetic force an external magnetically coupling electrical connector configured for close fit in said recessed magnetic connecting port, said external magnetically coupling electrical connector being secured in a battery holding pocket of a heating wearable and connected by a concealed cable having wires to transmit electrical current to one or more electrically conductive heating circuits secured in said heating wearable.

46. The rechargeable portable dc battery as claimed in claim 42 wherein said external magnetically coupling electrical connector is formed integral with a support harness, said support harness defining a stitch allocation seam area for securement of said external magnetically coupling electrical connector to a rear wall of said battery holding pocket, said harness also defining a pull tab which projects above said battery when said battery is placed in said battery holding pocket with said external magnetically coupling electrical connector retained in said recessed magnetic electrical connecting port by a magnetic field produced between said magnetically coupled connectors.
